(19) United States
(12) Patent Application Publication
(10) Pub. No.: US 2005/0160062 A1
(43) Pub. Date: Jul. 21, 2005

(54) Method to report personal security information about a person

(76) Inventors: W. Brant Howard, Parker, CO (US); Kevin Lasswell, Highlands Ranch, CO (US); Michae Whitt, Franktown, CO (US)

Correspondence Address: THE MCINTOSH GROUP, 8000 E. PRENTICE AVE., SUITE B-6, ENGLEWOOD, CO, 80111, US

(21) Appl. No.: 10/813,582

(22) Filed: Mar. 31, 2004

Related U.S. Application Data
(60) Provisional application No. 60/537,446, filed on Jan. 16, 2004.

(51) Int. Cl. G06F 7/00

(52) U.S. Cl. 707/1

(57) ABSTRACT

The present invention provides a method for providing an easily accessible and easily understandable source of information. The information provided comes from a multitude of sources and from a multitude of different information types. More particularly, the present invention provides a portfolio of web services delivered to a consumer through a website portal model. The web services help provide security information to a person. A person uses the services to assess, alert, inform, and enable them to make the most effective response to safety concerns.

### CROSS REFERENCES TO RELATED APPLICATIONS

In relation to this utility application, applicants claim priority to earlier U.S. provisional application Ser. No. 60/537,446 filed in the United States Patent and Trademark Office on Apr. 1, 2004, the entire disclosure of which is incorporated by reference herein.

### STATEMENT REGARDING FEDERALLY SPONSORED RESEARCH OR DEVELOPMENT

Not Applicable

### REFERENCE TO A “MICROFICHE APPENDIX”

Not Applicable

### BACKGROUND OF THE INVENTION

1. Field of the Invention

The present invention relates to methods of enhancing a person's security in their information and person. In particular, the invention involves a method of providing a person with multiple sources of information in one place to easily manage, respond, and understand their security position.

2. Description of the Related Art

After the attacks on Sep. 11, 2001, people around the world have become more aware of their personal safety. Personal safety is a concern for all people. Yet, as the world grows more complex, the ability of ordinary citizens to manage their own safety has become difficult or even impossible. People must receive, process, and respond to an inordinate amount of information that relates to their safety and security. This information includes risks to the person's physical safety, risks to the person's financial security, risks to the person's identity, and numerous other risks.

To manage the information received, a person must interface with a multitude of entities. Currently, a person contacts each entity individually to obtain a specific item of information. An example of the current methodology is reflected in U.S. Patent Application 2002/0087460 to Hornung. In this patent, a consumer provides initial information. This initial information allows credit agencies to send notices, to the consumer, of changes in the consumer's credit history. The consumer may then respond to the changes. As with the other prior art, Hornung only provides information from one type of information—credit history. The current systems are based on fragmented solutions that are cumbersome and not easily operated.

In addition, a person must often write or call the entity to obtain the information. These antiquated communication methods cause delays in receiving information. In addition, the information is presented in a form, whether a paper report or a phone message, that is hard to store and difficult to correlate with other information.

Thus, there is a need to provide security information and other information more easily and more readily.

### BRIEF SUMMARY OF THE INVENTION

The present invention provides a method for providing an easily accessible and easily understandable source of information. The information provided comes from a multitude of sources and from a multitude of different information types. More particularly, the present invention provides a portfolio of web services delivered to a consumer through a website portal model. The web services help provide security information to a person. A person uses the services to assess, alert, inform, and enable them to make the most effective response to safety concerns.

### BREIF DESCRIPTION OF THE SEVERAL VIEWS OF THE DRAWINGS

FIG. 1 shows a block diagram of an embodiment for an information receiving system communicatively coupled to a plurality of information sources providing several types of information and to a user in accordance with the present invention.

FIG. 2 shows a more detailed embodiment of the information receiving system in accordance with the present invention.

FIG. 3A shows one embodiment of a method to provide multiple types of information to a consumer through a single source in accordance with the present invention.

FIG. 3B shows one embodiment of a method to provide multiple types of information to a consumer through a single source in accordance with the present invention.

FIG. 4A shows a second embodiment of a method to provide multiple types of information to a consumer through a single source in accordance with the present invention.

FIG. 4B shows a second embodiment of a method to provide multiple types of information to a consumer through a single source in accordance with the present invention.

FIG. 5A shows a third embodiment of a method to provide multiple types of information to a consumer through a single source in accordance with the present invention.

FIG. 5B shows a third embodiment of a method to provide multiple types of information to a consumer through a single source in accordance with the present invention.

FIG. 6 shows an embodiment of a method to secure an electronic device in accordance with the present invention.

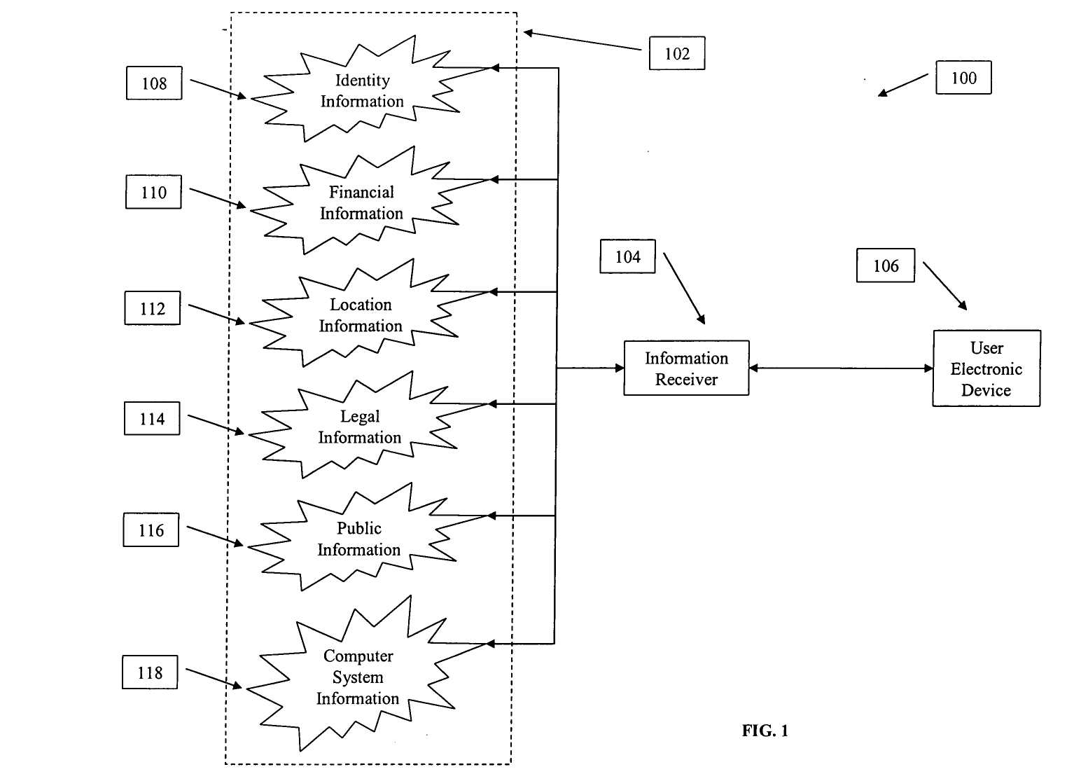

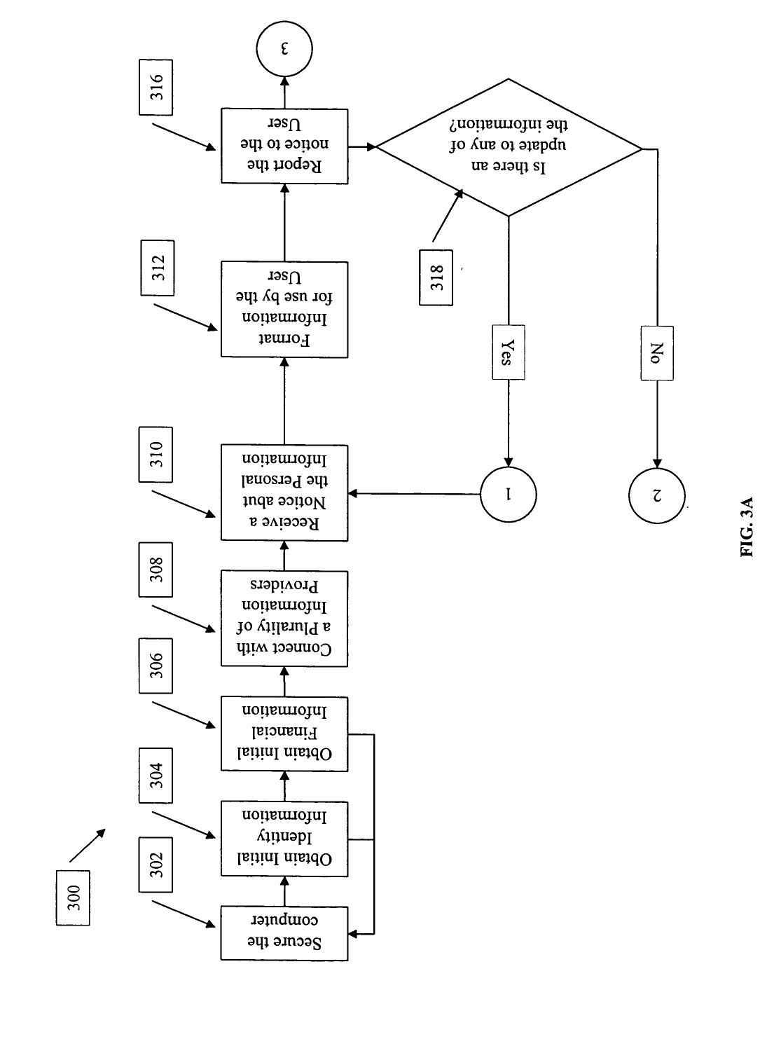

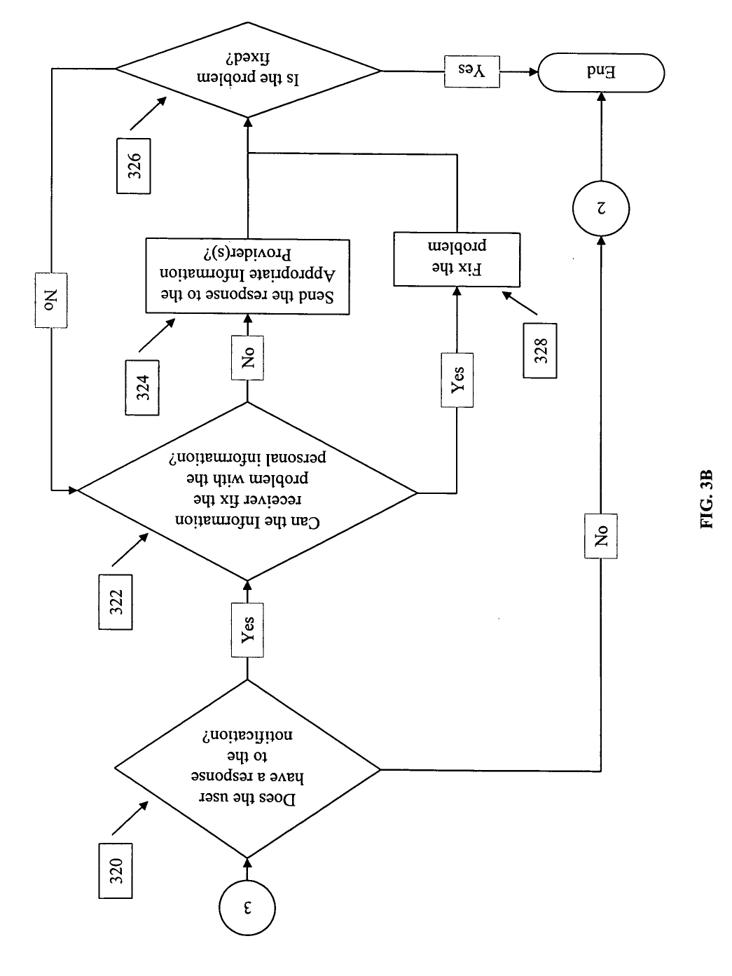

To clarify, each drawing includes reference numerals. These reference numerals follow a common nomenclature. The reference numeral will have three digits or four digits. The first one or two digits represent the drawing number where the reference numeral was first used. For example, a reference numeral used first in drawing one will have a numeral like 1xx, while a numeral first used in drawing four will have a numeral like 4XX. The second two digits represent a specific item within a drawing. One item in FIG. 1 may be 101 while another item may be 102. Like reference numerals used in later drawing represent the same item. For example, reference numeral 102 in FIG. 3 is the same item as shown in FIG. 1.

### DETAILED DESCRIPTION OF THE INVENTION

The present invention will now be described in reference to embodiments of the invention presented in the description below with reference to the attached figures. However, the invention is not limited to those embodiments as one skilled in the art will understand equivalents that are within the scope of the invention. The scope of the invention is as defined in the claims.

FIG. 1 shows a block diagram of an information receiving system 100 that may be used for the present invention. The information receiving system 100 includes two or more information providers 102, an information receiver 104, and a user or person (user electronic device) 106. These entities may be communicatively coupled. Throughout this description, communicatively coupled may mean any type of electronic or electrical connection including, but not limited to, LANs, WANs, wireless LANs, Virtual Private Networks, cellular or wireless systems, or satellite communication systems. In the exemplary embodiment, communicatively coupled is a connection through electronic pathways via the internet.

Information providers 102 are any entity, whether a business, organization, person, database, or electronic system that attends to personal information. Attending to personal information may include, but is not limited to, storing, modifying, or creating information about a person. The information receiver 104 is connected to at least two information providers 102. At least one information provider 102 connected to the information receiver 104 provides personal information that is in a different class or is a different type of information than at least one other information provider 102. For example, the information receiver 104 in the embodiment shown is connected to six information providers. Each of these information providers 102 provides a different type of information: identity information 108, financial information 110, location information 112, legal information 114, public information 116, or computer system information 118. The types or classes of information are not limited to these exemplary categories.

Personal information can be any data that may describe or apply to a person or may apply to something with which a person is concerned. As explained above, personal information may be separated into separate classes or types of information. There may be one or more information providers 102 that send data that can be classified under one type of personal information. In addition, the classes of information may be categorized in more detailed classes than those types of personal information exemplified in FIG. 1. For example, a bank (like Wells Fargo or Citibank) and a credit reporting agency (like Experian, Equifax, or TransUnion) may both be considered financial information providers 110. However, the financial information class of information may be broken into smaller categories. Two credit agencies may provide credit scores but not daily account activity and fall into the same class of information provider 102. A bank may provide daily account activity on a person's checking account but not a credit score. Thus, the bank and the credit agencies, while falling under the broad category of financial information providers 110, may fall into separate classes of information providers 102 because they provide information that the other information provider 102 does not. To determine if one information provider 102 is providing data in a separate the class of information, one skilled in the art should determine whether that information provider 102 presents one or more items of data that the other information provider or providers 102 do not provide.

There are several examples of information that fall under the general information categories mentioned above. Identity information 108 can include any data that includes a physical or identification characteristic of the person. Identity information 108 may include, but is not limited to, use of a person's social security number, use of a person's driver's license number, use of a person's biometric information (including fingerprints, eye scans, picture, facial recognition, DNA typing, or other use of biometric data), or use of a person's military identification card. The financial dealings and financial position of a person generally encompass a person's financial information 110. Financial information 110 may include, but is not limited to, credit card usage, the creation of a new credit account, bank account transactions, credit reports, establishment of new financial accounts, retirement account transactions, or use or distribution of a person's credit report. Location information 112 may include information provided by an asset tracking system. These systems use GPS or other location finding devices to locate a person or object holding or using the device. The location is sent to an asset tracking system to process. Then the location may be sent to a user in a GIS format where the location is shown as a visual representation on a map. The location information 112 that may be shown includes, but is not limited to, the location of family members, the location of coworkers, the location of pets, the location of assets (such as cars, boats, motor homes, bicycles, etc.), the location of city service vehicles (such as the police, fire engines, snow plows, etc.), the location of sex offenders living in the area, or the location of buildings (such as schools, hospitals, gas stations, etc.). Legal information 114 may include any information that affects or describes a person's legal status. For instance, this legal information 114 may include, but is not limited to, possible warrants, traffic tickets, parking tickets, summons, pending trials, or investigations into the person. Public information 116 is data or notices provided by civic or public safety organizations. Some examples of public information 116 may include, but is not limited to, homeland security messages, public address messages, meeting notices, pending votes on legislation or codes, reverse 911 messages, or school closings. Computer system information 118 is information about a user's electronic device or home computer system. Computer system information may include, but is not limited to, software updates available, virus update files, recalls, hardware failures, scheduled maintenance, or password updates. The examples given above do not encompass all possible information that may be managed by and in the present invention. Other information that would fall into the above categories and into other unmentioned categories is contemplated.

The information receiver 104 may be a system that receives information from the plurality of information providers 102 and provides that information to the user 106. The information receiver 104 may be an electronic system or a software system. In one embodiment, the information receiver 104 would be a separate entity that would receive information from a plurality of information providers 102 and forward information to a plurality of users 106. Another embodiment would embed the information receiver 104 into a computer or electronic device operated by the user 106. In this embodiment, the user 106 would access the information receiver 104 by operating the hardware or software embedded in the user's computer system 106. No internet or other communicative couple would be needed between the user 106 and the information receiver 104. One skilled in the art will recognize the changes to the information receiving system, as will be explained below, that will be needed to create this embodiment.

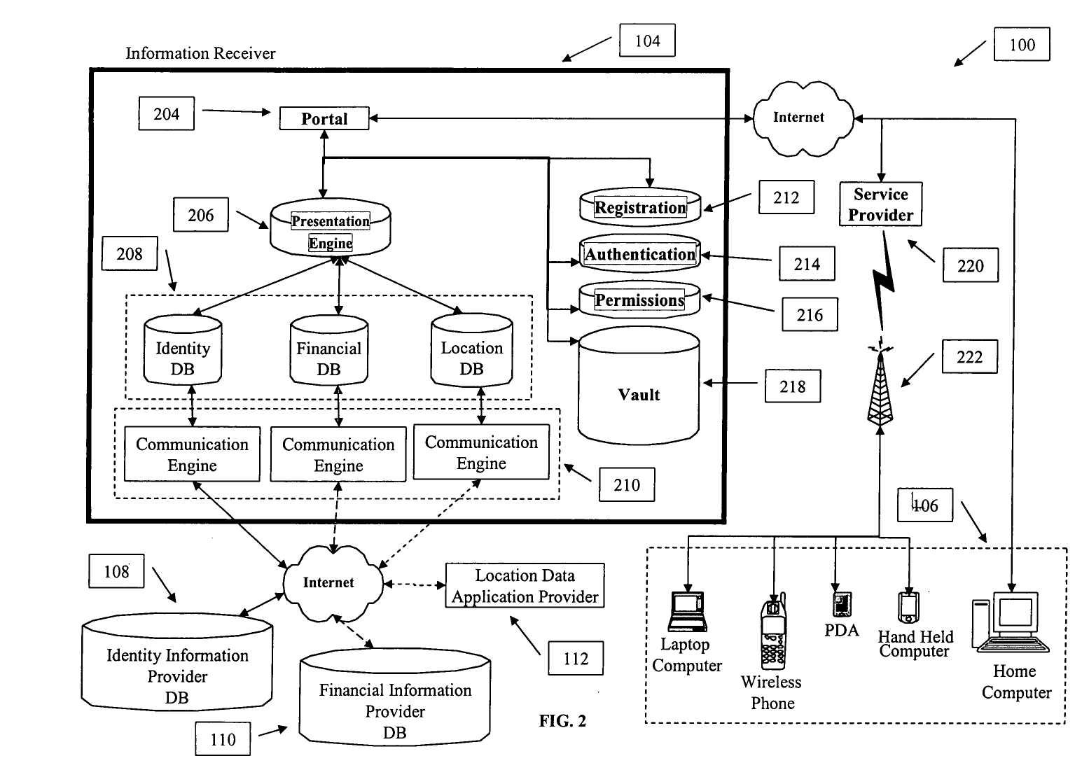

A more detailed embodiment of the information receiving system 100 is shown in FIG. 2. This embodiment shows the information receiver 104 operating outside and independent from the user 106. In other words, the information receiver 104 is a separate entity that manages stores, consolidates, formats, and transmits the information to the user 106. As mentioned above, the information receiver 104 can be co-located or integrated with the user 106 or into the user's computer system. This alternate embodiment includes a software program or electronic device used at the user's home or in the user's computer to act as the information receiver 104. These two embodiments have similar components and the second embodiment will not be explained further. However, one skilled in the art will recognize the small changes that would need to be made to integrate the information receiver 104 into the user's systems 106.

Starting from the user 106 in FIG. 2, the present embodiment demonstrates that the user or the user's electronic device 106 may represent one or more of several devices. The security information may be reported to one or more of these devices 106. The electronic device 106 can be any device that may be communicatively coupled to the information receiver 104, receive information signals, and provide a message to the user 106. The message sent to the user 106 may be an audio, video, or text message. The means of transport for the signal is immaterial as the signal may include, but is not limited to, a wireless, cellular, telephone, internet, or satellite communication. Some of the electronic devices 106 that may be used in the present invention include, but are not limited to a user's home computer, a display device, telephone, a laptop computer, a wireless or cellular phone, a personal digital assistant (PDA), a server, a mainframe or a hand held computer.

As some of the electronic devices 106 may not have direct access to the internet, the present invention may also include one or more service providers 220. While the user may contact the information receiver 104 directly as shown, one or more service providers 220 may pass the information to the user 106. For instance, the information receiver 104 may send the information onto a television signal provider, such as DirecTV, which would forward the information to the user's television. In other embodiments, the user 106 may access the information through an ISP. Still in another embodiment, the user 106 may receive information on his or her cellular phone via a cellular phone system or wireless system 222. Wireless systems allow nearly immediate notification of the user 106, regardless of the location of the user 106. Other service providers 220 are contemplated and included in the present invention.

The detailed embodiment of the information receiving system 100 includes a detailed embodiment of the information receiver 104. The information receiver 104 is communicatively coupled to the one or more of the electronic devices 106. The information receiver 104 may include, but is not limited to, a computer, a computer system, a mainframe, a server, or other electronic system. The embodiment of the information receiver 104 can have several components or subsystems.

Components of the information receiver 104 may include one or more of, but are not limited to, an information portal 204, a registration system 212, an authentication system 214, a permissions system 216, an information vault 218, a presentation engine 206, or one or more databases 208, or one or more communications engines. The information portal 204 is the interface between the user 106 and the information receiver 104, which provides the electronic connection between the information receiver 104 and the electronic devices 106. This portal 204 may receive or send information from and to the user 106. Information portals 204 can be routers, switches, and other internet or electronic communication systems that are well known in the art and will not be explained further.

The registration system 212, authentication system, and permissions systems may be software or hardware systems. The registration system 212 ensures that the user 106 is allowed access to the information receiver 104. The registration system 212 requires the user 106 to enter some of their personal information to gain access to the information data. Thus, the registration system 212 directs the presentation engine 206 to send information upon request by the user 106. In addition, the registration system 212 helps establish what data the information receiver may receive on behalf of the user 106. In other words, what types of information upon which the user 106 wants to receive updates. The registration system 212 may also be the initial program used to establish the user 106 as a client of the information receiving system 100.

The authentication system 216 may be any system that verifies that the user has access to the particular information. For instance, the authentication system 214 may use a login and password protocol to prevent unauthorized access. Other systems and data may be used to authenticate the user's allowed access, such as biometric data or other information. Authentication systems 214 are well known in the art and will not be explained further.

A permissions system 216 may limit the amount of access to the user 106. For instance, the permissions system 216 may only grant access to a user to his financial or public information. This permissions system 216 more accurately allows more than one user access to some mutually important data but not to each person's complete data. For instance, a wife may have access to the husband's shared bank account but not to his retirement account information. Permission systems 216 are well known in the art and will not be explained further.

The information vault 218 is a data storage system. In an exemplary embodiment, the vault 218 is a database stored in some type of memory. The memory may be a RAM, ROM, hard drive, tape storage, optical disc storage, or other device. The vault 218 may be protected by one or more security measures. These measures may include password protection or encryption. The vault 218 stores all or a portion of the personal information obtained either from the user 106 or from the information providers 102. The vault 218 may also store other information received for latter transmittal or for use in reports or presentations that may be made at a latter time.

The presentation engine 206 is the system or software module that receives, retrieves, consolidates, formats, or transmits the personal information. For instance, when a user 106 requests a credit report, the presentation engine 206 may retrieve the data, put it in an easily understandable format, and transmit it to the portal 204 for forwarding to the user 106. The functions of the presentation engine 206 are described in more detail below.

The information storage 208 are the databases for the different types of information. There can be a single physical database with different relational or database substructures or there can be more than one physical database. In the exemplary embodiment, each physical database 208 shown stores or holds personal information representing a single type of information. For instance, the identity database may store information from identity information providers 108. The financial database may store information from financial information providers 110. Each type of data may be parsed out to a different database. There may be as many databases as there are types of information that need to be stored. Databases are well known in the art and will not be explained further.

Each database 208 may interface with a communication engine 210. The communication engine 210 may be communicatively coupled to one or more information providers 102. The information providers 102 may include data providers and application providers. Data providers supply raw information; application providers provide access to or output from other processes, such as an asset tracking system. The connection to the information providers 102 may be made through different systems. Thus, there may be a communication engine dedicated to each type of information or dedicated to each information provider. This dedicated approach allows the interfaces, both as to type of communication system and communication protocol, to be specified for every information provider 102 (as is represented by the different solid or dashed lines in FIG. 2). Thus, there are as many communication engineers 210 as there are different communications systems or protocols. For example, one financial information provider 110 may provide XML files over an internet connection, while a public information provider 116 may provide Acrobat Reader files over a LAN. The present embodiment uses an internet connection, but the invention is not limited to that one embodiment. As the communication engine 210 depends upon the type of connection between the information provider 102 and the information receiver 104, the structure and function of the communication engine 210 will differ. However, communication engines 210 are well known in the art and need not be explained further.

Finally, two or more information providers 102 are communicatively coupled to the information receiver 104. Some information providers 102 may include, but are not limited to, credit reporting agencies (such as Experian or TRW), banks (such as Citibank, Wells Fargo, or First National Bank), retailers (such as Sears or WalMart), civic organizations (such as Federal agencies, town councils, police stations, or school administrations), courts, or third party systems (such as asset tracking systems or computer software companies). One skilled in the art will recognize that the sources of information are as numerous as the information itself. Therefore, there are other information providers 102 that are included in the present invention. Method of Receiving and Reporting Information to a User

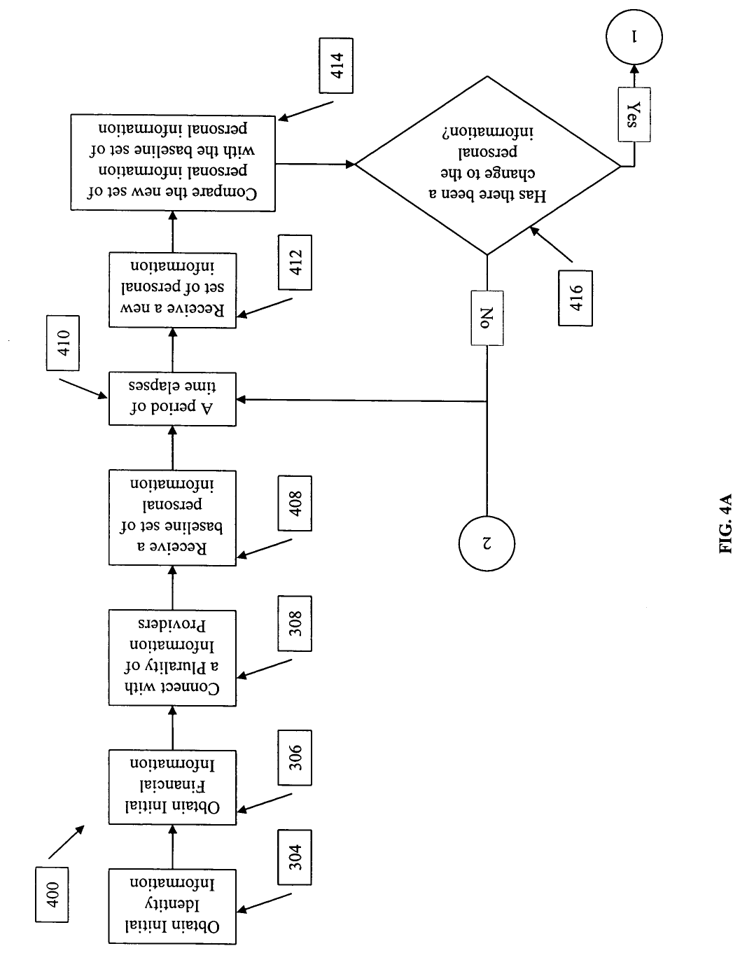

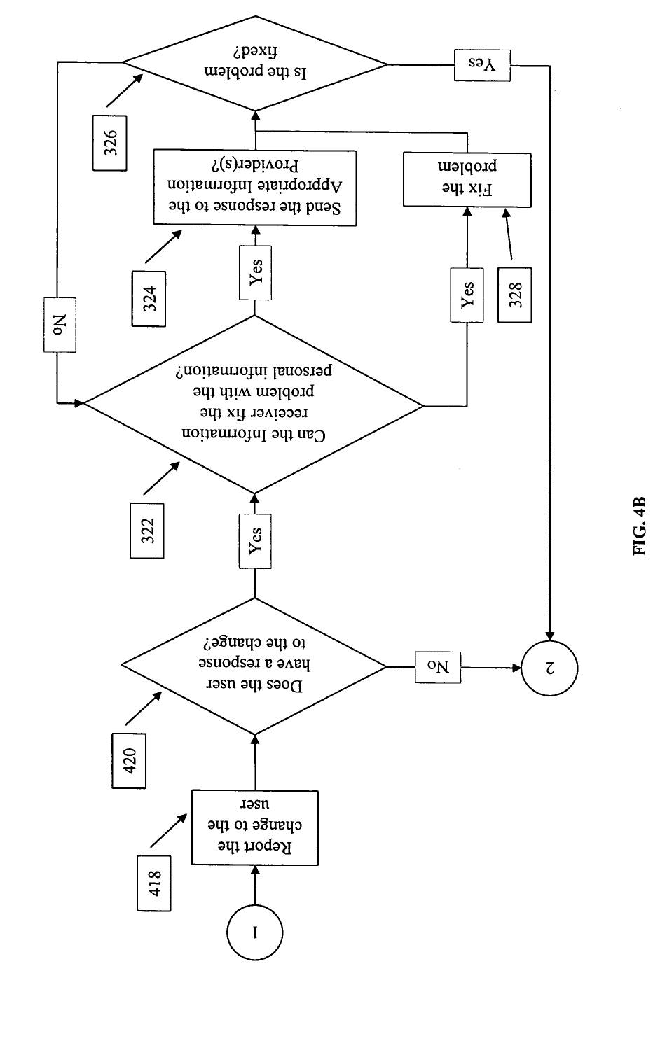

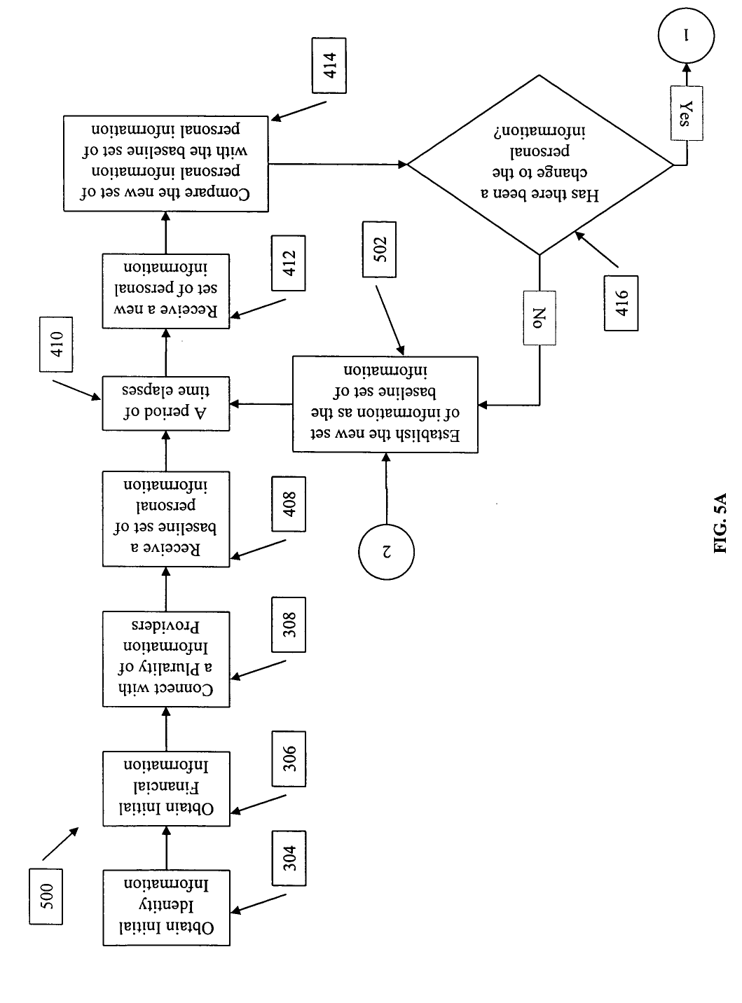

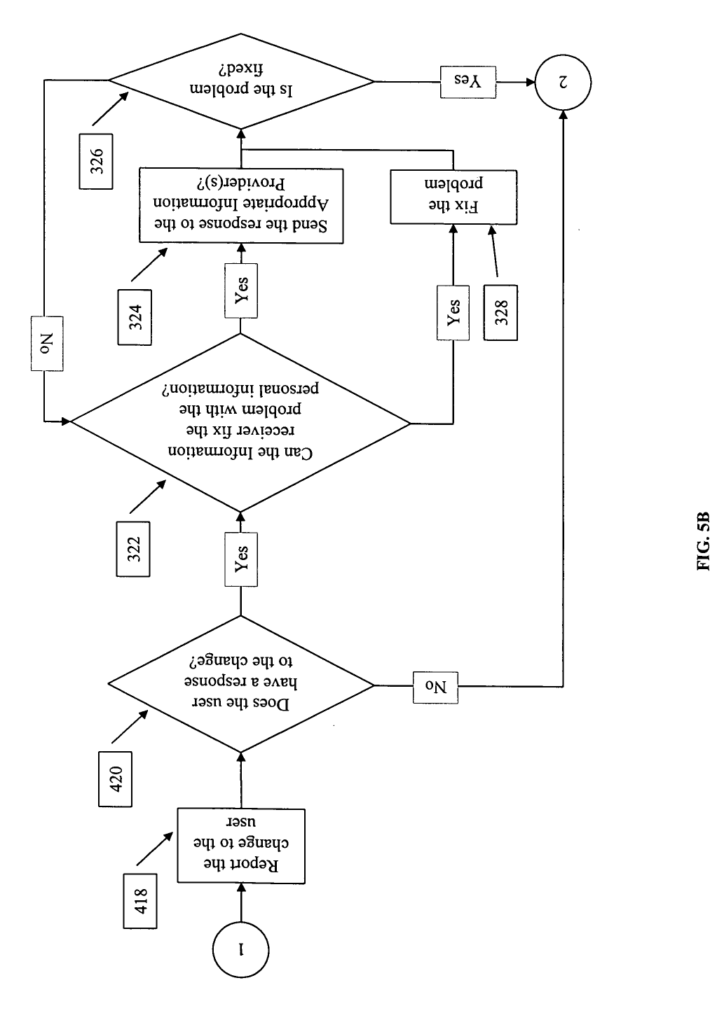

FIG. 3A, FIG. 3B, FIG. 4A, FIG. 4B, FIG. 5A, and FIG. 5B show embodiments of methods 300, 400, and 500 for providing information in a single source from two or more information providers. While the embodiments show several steps, the present invention may have more or fewer steps than the embodiments presented. Many of the steps or processes in the methods are the same or similar. Thus, these similar steps will be explained only once. The differences between the three embodiments will be described in more detail.

The methods all require that the information receiver 104 obtain initial personal information about the person 106, connect with two or more information providers 102 that attend to personal information in two or more classes of information, receive one or more items of information from one or more of the information providers 102, and report the one or more items of information to the person 106. These steps will be discussed in more detail below.

The information receiver 104 must obtain initial personal information about the person or user—either initial identity information 304, initial financial information 306, or both. To protect the appropriate information, the information receiver must know that information. Some examples of the initial identity information may include, but is not limited to, a person's name, address, birthday, SSN, mother's maiden name, driver's license number, height, weight, hair color, or eye color. Some examples of the initial financial information may include, but is not limited to, a person's bank account numbers, credit card numbers, loans outstanding, investment accounts, place of employment, or retirement accounts. The initial information helps determine which information providers will be connected with and identify the person or the items the person is concerned about. For example, to protect a person's social security number, the information receiver 104 must know and recognize the number. Obtaining 304 and 306 the information may be completed in various ways by various means.

The person or user 106 may provide the information to the information receiver 104 through the registration system 212. Providing the data may include simply entering the information into the person's computer by the keyboard, mouse, or other man/machine interface and transmitting the initial information to the information receiver 104. There may be other methods of providing 304 and 306 the initial information. For instance, the user 106 may scan their Social Security Card into a computer, the user 106 may store their fingerprint into the computer using a biometric scanner, or the user 106 may read the information to a voice recognition program, and the initial information can be transmitted to the information receiver 104. In another embodiment, a software program may search the memory of a computer for electronic files that carry personal information. The software program may, for instance, scan the memory of the computer for nine digit numbers that may be social security numbers (SSN). The program may then ask the user 106 if this is their SSN. If the user 106 responds that the number is their SSN, then that number may be transmitted to the information receiver 104. The means and method of providing the information may vary and may use several different methods.

After the initial information is obtained, the information receiver 104 connects 308 with a plurality of information providers 102. Connecting with an information provider 102 means both communicatively coupling with the information provider 102 and establishing a relationship with the information provider 102 where the information provider 102 agrees to supply personal information. One advantage of an information receiver 104 independent from the user 106 is that only one connection to each information provider 102 need be made for numerous users 106. Thus, when the information receiver is already connected to the information provider, connecting may involve adding the new user to the list of personal information that the information provider 102 needs to monitor and to report. The information receiver 104 must connect with two or more information providers 102. In addition, at least one of the information providers 102 must supply personal information in a different class than at least one other information provider 102. For example, if one information provider supplies financial information then one other information provider must supply identity information, public information, or some other class of information. Again, the classes of information are not limited to these broad categories, but the classes may be separated into more detailed categories. It is possible to have two or more information providers supplying information in the same class of information, if one other information provider is supplying personal information in a separate class. For instance, the information receiving system may include connections to three credit agencies, Experian, TransUnion, and Equifax. However, the information receiving system would also be connected to a bank, like Wells Fargo, or to a public information provider, like U.S. Department of Homeland Security.

Once the connections are established, the three embodiments differ. FIG. 3A includes an embodiment where the information receiver 104 receives a notification or notice 310 about the person's personal information. Notice and notification are used interchangeably and are meant to mean the same thing. This notice may be forwarded 316 to the user 106 in its original format or a modified format, as will be explained later. The notice may include a message that simply tells the user 106 that a change in their personal information has been made. In this embodiment, the user 106 would need to make a request as to what was changed and how it was changed. The information receiver 104 may answer the request or forward the request to the appropriate information provider or providers 102. The response may be received by the information receiver 104 from the information provider or providers 102 and be sent to the user 106 containing the changed information. In another embodiment, the notification contains the changed information already, and the user 106 need not make a request for the information. In another embodiment, the notice is sent to the user 106 after an update 318 to the information. This situation may occur when a use of a person's SSN occurs. Rather than report each day whether a use occurred, the information receiving system 100 would update the user 106 on that particular day only if a use of the SSN had occurred. Another embodiment of the receiving information may include the user 106 sending a request to the information receiver 104 that is forwarded to the information provider 102. The information provider and information receiver may send a response. This request and response situation may occur with the person's credit report. A request to view the credit report may be sent to a credit reporting agency. A response to that request, with the credit report attached, may be set back to the user 106.

In other methods shown in FIG. 4A and FIG. 4B, the information receiver 104 may receive 408 a baseline set of personal information. The baseline set of information can contain all or a portion of the personal information about the user 106 that is stored by any information provider 102. The information receiver 104 can send the baseline set of information to the user 106. Then, the user 106 may verify the correctness of the baseline information by reviewing it for accuracy. If the information is incorrect, the user 106 may send a response to the information receiver 104 or the appropriate information provider or providers 102 to correct the problem. Once the problem is corrected or if the baseline information is already correct, this baseline set of information may be stored in the user-specific vault or in the information type specific database.

Now, the information receiver 104 may periodically provide change information to the user 106. A period of time elapses 410. The duration of the period of time is immaterial and may be an hour, a day, a month, a year, or any other measure of time. In addition, the period does not need to be regular. Thus, the period need not be constant or consistent. Instead the period of the updates may vary such that it may be everyday for a week, then change to once a week for two months, and back to once a day for three weeks. Regardless, one or more information providers 102 can send a new set of personal information to the information receiver 104. The information receiver 104 may receive 412 this new set of information. The information receiver 104 may make a comparison 414 between the new set of information and the baseline set of information. The information receiver 104 determines if any changes have been made 416 between the baseline set of information and the new set of information. If a change has been made, the information receiver can notify 418 the user of the change. This notification can be the same of similar to the notification mentioned earlier. Thus, the notice may include the change or simply bring the user's attention to the change. If no change has been made two things may happen. In FIG. 4A, the information receiver 104 may simply wait for a new set of information to be received. Thus, the baseline set of information never changes, and all comparisons in the future happen with the same set of baseline information. In FIG. 5A, the new set of information is established 502 as the new baseline set of information. Thus, each subsequent comparison happens with the last set of information received by the information receiver 104. The second embodiment creates a continually changing set of baseline information that can better track the user's changes in his or her information. These periodic updates may occur with the person's bank account data. For instance, every day the bank may send the account balance and the days charges and credits to the information receiver 104. The information receiver 104 will compare the information to a baseline set of information and forward the changes to the user 106. Thus, the user 106 obtains a periodic update of their accounts everyday.

In all three embodiments in FIG. 3A, FIG. 4B, and FIG. 5B, the information receiving system 100 must report a notification 316 or report of a change 418 to the user 106. Reporting the information includes methods of taking the received information (whether notices or new sets of information) and presenting it to the user 106. The presentation may come in different formats that may include, but is not limited to, a visual presentation, an audio presentation, a report that may be printed, a warning message, or a tactile report (for instance, a Braille system for the blind). The presentation may be made on one or more of the user's computer, display device, wireless receiver, cellular phone, personal digital assistant, email address, website, telephone, or other device.

In a further embodiment, the user 106 may want to respond to the notice or report of the change. The user 106 can determine whether a response is needed to anything in the notification 320 or anything in the report of the change 420. The user 106 may send a message, email, Instant Message, phone call, or other transmission either to the information receiver 104 or to the information provider 102 directly. A message sent to the information receiver 102 may require the information receiver to determine 322 if the user's response can be addressed without forwarding the message to the information provider 102. If the information receiver 104 can address the response, the information receiver 104 fixes the problem 328 with the report, notification, or the personal information. If the information receiver 104 can not address the response, the information receiver 104 sends the response 324 to one or more of the information providers 102. The information receiver may then monitor if the problem is fixed 326. Once the problem is fixed, the information receiver 104 may wait for a new set of information or a new notification caused by an update to the personal information 318.

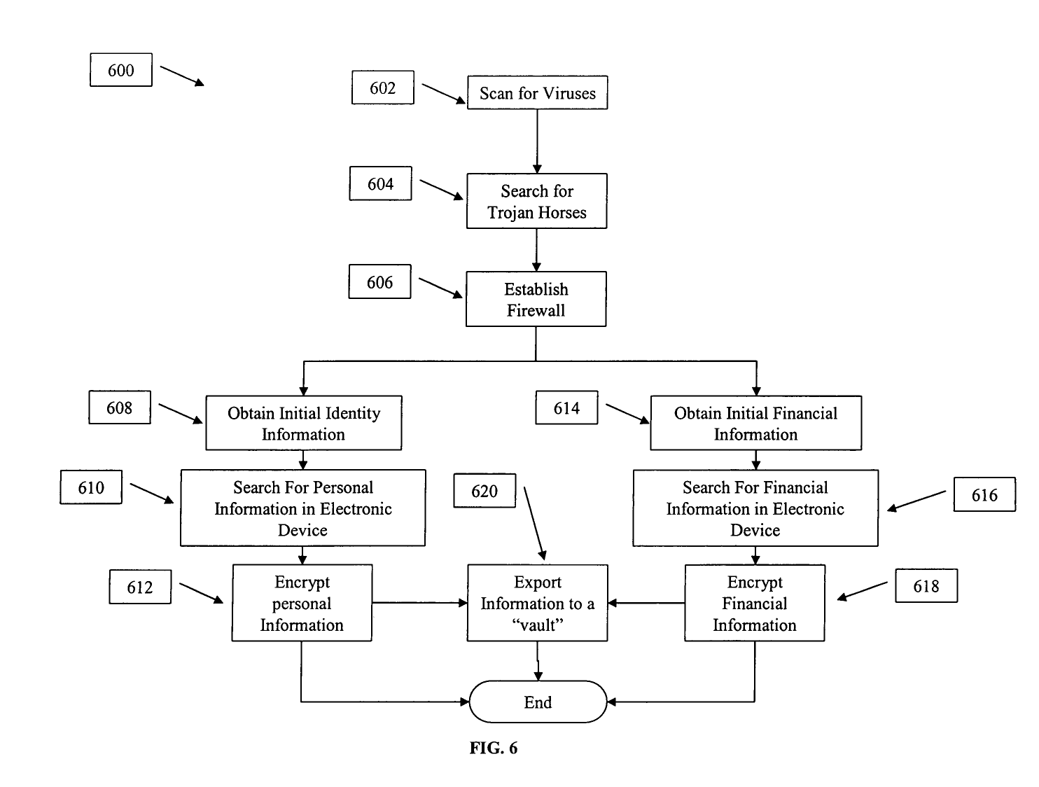

FIG. 3A includes other steps in the process that may be included in any of the embodiments of the present invention. For instance, another step in the process may include securing the user's computer or electronic device 302. A method 600 of securing the person's electronic device 106 is shown in FIG. 6. Securing an electronic device may include, but is not limited to, scanning for viruses 602, searching for Trojan Horses 604, establishing firewalls 606, encrypting information 612 and 618, or storing information 620 in a secure location. Scanning for viruses 602, establishing firewalls 606, and encrypting information 612 and 618 are well known in the art and will not be explained further. A Trojan Horse is a program embedded in the electronic device's 106 software that tracks the user's actions and reports those actions to an outside entity. Searching for Trojan Horses 604 is well known in the art and will not be explained further. Some information may be removed from the electronic device 106 and stored 620 in the vault 218. As shown in FIG. 6, securing 302 the electronic device 106 may also include receiving the initial information 304 and 306, then searching 610 and 616 the person's electronic device 106 for that information. If the information is found on the electronic device 106, the information may be either encrypted 612 and 618, moved to the vault 620, or both. The information found on the electronic device 106 may also be password protected. Password protecting information is well known in the art and will not be explained further. Any of these methods may be used alone or in conjunction and other methods known in the art may also be used to protect the personal information already on the electronic device 106.

Referring again to FIG. 3A, the information receiver 104 may format 312 the notices or personal information received form the information providers 102 before reporting the information. In some embodiments, the information receiver 104 may pass through the information received by the information providers 102. However, most embodiments will require the information receiver 104 to format or change the style, protocol, structure, language, or some other characteristic of the information before transmitting the information to the user 106. Formatting the information includes the information receiver placing the information into a presentation for use by the user 106. In most embodiments, the information receiver 104 presents the information in a form that is easily understood by the user 106. For instance, determining if an unauthorized account has been opened in the person's name may be daunting for the user 106. The credit report must be reviewed, with the intention of eliminating all current, legitimate accounts. The information receiver 104 may have the current accounts stored and eliminate those entries. The formatted presentation would leave a listing of new accounts that are currently unrecognized. Thus, the formatting made the credit report more easily understood. One skilled in the art will recognize other functions that may be considered formatting the information.

The information receiver 104, as a function of the formatting, may also consolidate information. The information receiver 104 allows the receipt and reporting of single pieces of information. However, in most embodiments, the formatted presentation will include two or pieces of information from two or more information providers 102. Thus, the consolidated presentation will incorporate the two pieces of information. For example, a credit report may be consolidated with a person's bank statement. In this embodiment, the person may view what accounts exist along with their current activity. Consolidating information may also include combining pieces of information. Combining information includes using two or more pieces of information to create a new piece of information. For instance, a charge on a credit card may have an address and a time stamp. The charge may be shown on a map from asset tracking system. The location of the person's cell phone (and necessarily the person) during the time of the credit card charge may be shown on the same map. Thus, the person can decide if he or she was at the place when the charge was made or if someone has stolen his or her credit card or account number.

### EXAMPLE

John Smith purchases a DirecTV system and signs up for the DirecTV service that provides television programming provided by a satellite signal. As part of the content or programming offered by DirecTV, the satellite television provider 220 allows Mr. Smith to sign-up for a personal information security system. The service allows John to view the status of his personal information and helps him respond to issues with his personal information.

John selects the service and provides some initial information to an information receiver 104. He gives some identity information, including his name, address, SSN, and his driver's license number. He provides some financial information, including his bank account numbers, his credit card numbers, and his retirement account numbers. John also provides a set of cellular phone identification information for his family's three cellular phones. The identification information is the number used to identify the cellular phone in the cellular system. Every cellular phone has an identification number that allows the cellular phone system to track the minutes called by the phone and identify that the phone belongs to a certain cellular service. Mr. Smith gives one phone to his wife Jane and the other to his son Billy. In addition, John purchases a special dog collar with a dog tag that can both receive GPS signals and transmit those signals over the cellular phone system. He puts the dog collar on the family's pet named Fido.

DirecTV 220 sends Mr. Smith two set-top boxes 106. These systems 106 include a hard drive, electronic components, and operating systems capable of operating a GIS System/Image Formatter program. In this example, the set-top boxes 106 have the regional maps of John's home state. After the set-top boxes 106 are installed at Mr. Smith's home, he can contact the information receiver 104 to authorize his system 106 to receive notices about his personal information. DirecTV receives the identification numbers from John's two set-top boxes 106. These identification numbers specifically identify those set-top boxes 106 in the satellite television system. A customer number is given to John for his service. John's two set-top boxes 106 are authorized by downloading commands over the satellite transmission to the boxes with their identification numbers. The authorization programs the set-top boxes 106 to receive certain programming or content including the personal information. Channels usually describe an analog television tuning to a certain broadcasted frequency, but the term is used here to describe a certain signal of digital television that carries specific programming content—like HBO, CNN, ESPN, etc.

DirecTV provides the customer number to the information receiver 104 and establishes a format for the signals that will go to John Smith. In this example, DirecTV 220 will receive personal information from the information receiver 104 with a header that includes the service provider's TCP/IP internet address. The information receiver 104 then connects with several information providers 102 that attend to John's personal information. These information providers 102 include Equifax, his banks, his credit card companies, his local fire department, his local police department, and an asset tracking service. The information receiver 104 then begins receiving data from the information providers 102 listed for John Smith.

One day, John begins to worry that Billy has been lying to John about some of his extracurricular activities. Billy has been telling his dad that he has been studying at the library every night for three hours. Unbeknownst to young Billy, John has given Billy a new cellular phone device with a built-in GPS receiver. The new phone sends GPS coordinates to the asset tracking service and are relayed to the information receiver 104 then onto John's DirecTV system where John can see Billy's location throughout the day. One evening, when Billy is assumedly at the library, John turns to the personnel information channel on his television system.

Billy, who is at the local arcade, has his cellular phone in his pocket. The cellular phone receives a transmission from several GPS satellites (or triangulates from several cell towers). The signals are interpreted into a GPS coordinate location. This location is formed into a message and a header. Every five minutes the cellular phone sends an internet transmission to the asset tracking service with the GPS coordinates. The asset tracking service sends the information onto the information receiver 104. The message is reformatted to make it easier to send to John over the DirecTV system and to make it easily understandable. At a router, the message is transmitted to DirecTV.

Once received at DirecTV's internet router, the message is multiplexed into a stream of numerous location content messages. In essence, Mr. Smith's message becomes one of many similar messages all in the location content bit stream. This stream is multiplexed into the satellite transmission and beamed to the satellite. At John's home, the personal information stream is demultiplexed from the satellite transmission by his two set-top boxes 106.

The GIS System on Mr. Smith's set-top box 106 then determines where the GPS coordinate is located using the GIS database and files stored on the system. Once the location is determined, the GIS System obtains a map from the database and locates an icon, for instance a small boy for Billy, on the map. The GIS Image Formatter creates an image file, such as an MPEG file of the map and the icon. This file is sent to the display device.

On the display device, John Smith can see that his son is at the arcade. Also, through a similar process, the dog, Fido, is shown as located at the veterinarian's office with his wife, Jane. Both the wife icon and the dog icon are shown at the same place. An address may be given for the different locations. For instance, the location for his wife and dog may read, “Peterinarian, 1800 Main St., Smalltown, Colo.” Other information may be provided including, but not limited to, telephone numbers, directions to a location selected, advertising materials, the condition of the asset being looked at, or a direction or speed of travel for the asset. Also, John may decide to play back the location data from Billy from the past two weeks. The data may show Billy has been at the arcade several times when he told his father that he was studying.

While viewing the location information, John gets a warning notice on his cellular phone that a new credit account has been established in his name. John knows that he has not applied for credit in the past month. John heads to his personal computer and brings up the information receiver 104 website. He uses a login and a password to enter the website information portal 204. Once on the website, John requests to see the credit account information.

The information receiver 104 stores a set of financial data for John in an information vault 218. A presentation engine 206 retrieves the new credit account information from the information vault 218 and sends a formatted page of information to the portal 204 and to John. John looks over the information and notices that the credit account was opened in another state. Immediately, John knows that someone has tried to steal his identity. John uses the website response tool to send a message to the information receiver 104 that the credit account has been created fraudulently.

The information receiver 104 forward John's message to the bank where the credit account was created. The bank quickly responds to the message by closing the account. Within a matter of minutes the new account was opened then closed. The bank lost no money and John's credit rating remains intact.

1. A method of managing information regarding a person's security from a plurality of information sources, comprising:
a. obtaining initial information about the person;
b. connecting with a plurality of information providers, wherein at least two of the information providers attend to personal information in a separate class of information;
c. receiving a notice about the personal information from one or more of the information providers; and
d. reporting the notice to the person.

2. A method of managing information according to claim 1, wherein the class of information is selected from the group consisting of identity information, location information, legal information, public information, computer system information, and financial information.

3. A method of managing information according to claim 1, wherein obtaining the initial information includes the person providing the initial information.

4. A method of managing information according to claim 3, wherein the person providing the initial information includes the person entering the initial information into a computer.

5. A method of managing information according to claim 1, wherein obtaining initial information includes an electronic device automatically scanning, for the initial information, in electronic files stored in one or more memories.

6. A method of managing information according to claim 5, wherein the electronic device is one of a desktop computer, a laptop computer, a mainframe, or a server.

7. A method of managing information according to claim 1, wherein connecting with the one or more information providers includes communicatively coupling an electronic device used by the person with the plurality of information providers.

8. A method of managing information according to claim 1, wherein connecting with the plurality of information providers includes communicatively coupling an information receiver with the plurality of information providers and communicatively coupling the information receiver with an electronic device operated by the person.

9. A method of managing information according to claim 1, wherein the notice is a message reporting that a change in the personal information has occurred, but does not include the changed personal information.

10. A method of managing information according to claim 9, further comprising:
a. requesting the changed personal information; and
b. receiving a response to the request that includes the changed personal information.

11. A method of managing information according to claim 10, further comprising sending the response to the person.

12. A method of managing information according to claim 1, wherein the notice includes at least a portion of changed personal information.

13. A method of managing information according to claim 12, further comprising sending the notice to the person.

14. A method of managing information according to claim 1, further comprising sending a request for a set of new personal information to one or more of the plurality of information providers.

15. A method of managing information according to claim 14, wherein the notice includes the new set of personal information.

16. A method of managing information according to claim 14, further comprising sending the notice to the person.

17. A method of managing information according to claim 1, wherein reporting the notice includes sending the notice to an electronic device operated by the person.

18. A method of managing information according to claim 16, wherein the electronic device is one of a computer, a display device, a wireless receiver, a cellular phone, a personal digital assistant, or a telephone.

19. A method of managing information according to claim 1, further comprising securing an electronic device used by the person.

20. A method of managing information according to claim 19, wherein the electronic device is one of a computer, a display device, a wireless receiver, a cellular phone, a personal digital assistant, a server, a mainframe, or a telephone.

21. A method of managing information according to claim 19, wherein the electronic device stores a portion of personal information in a memory.

22. A method of managing information according to claim 21, wherein securing the electronic device includes protecting at least a portion of personal information stored in the memory.

23. A method of managing information according to claim 22, wherein protecting the personal information includes at least one of password protecting the personal information, encrypting the personal information, or storing the personal information in an information vault.

24. A method of managing information according to claim 19, wherein securing an electronic device includes at least one of scanning the electronic device for viruses, establishing a firewall on the electronic device, searching for Trojan Horses on the electronic device, or encrypting a portion of data on the electronic device.

25. A method of managing information according to claim 1, further comprising formatting the notice before reporting the notice to the person.

26. A method of managing information according to claim 25, wherein formatting the notice includes creating a presentation about changes in the personal information that the person will easily understand.

27. A method of managing information according to claim 26, wherein the presentation is a visual presentation.

28. A method of managing information according to claim 1, further comprising consolidating two or more notices.

29. A method of managing information according to claim 28, wherein consolidating includes placing two or more notices into one presentation that presents at least a portion of information from each notice in the one presentation.

30. A method of managing information according to claim 28, wherein consolidating includes combining two or more notices into one new notice.

31. A method of managing information according to claim 1, further comprising:
a. receiving a response from the person to one or more notices; and
b. reacting to the response.

32. A method of managing information according to claim 31, wherein reacting to the response includes forwarding the response to one or more information providers.

33. A method of managing information according to claim 31, wherein reacting to the response includes fixing a problem indicated in the response.

34. A method of managing information regarding a person's security from a plurality of information sources, comprising:
a. obtaining initial information about the person;
b. obtaining a baseline set of personal information from a plurality of information providers and at least one of the information providers attends to personal information in a separate class of information;
c. receiving a new set of personal information;
d. comparing the new set of personal information to the baseline set of personal information; and
e. reporting any changes between the new set of personal information and the baseline set of information to the person; and
f. repeating steps c through e.

35. A method of reporting security information according to claim 34, wherein receiving the new set of personal information occurs periodically.

36. A method of reporting security information according to claim 35, wherein the period is regular.

37. A method of reporting security information according to claim 35, wherein the period one of a once a day, once a week, once a month, once a quarter, or once a year.

38. A method of reporting security information according to claim 35, wherein the period varies.

39. A method of reporting security information according to claim 34, further comprising formatting the report before reporting the changes to the person.

40. A method of reporting security information according to claim 39, wherein formatting the report includes creating a presentation about the changes that the person will easily understand.

41. A method of reporting security information according to claim 40, wherein the presentation is a visual presentation.

42. A method of reporting security information according to claim 34, further comprising consolidating two or more reports of changes.

43. A method of reporting security information according to claim 42, wherein consolidating includes placing two or more changes into one presentation.

44. A method of reporting security information according to claim 42, wherein consolidating includes combining two or more changes into one new report.

45. A method of reporting security information according to claim 34, further comprising:
A. receiving a response from the person to one or more reports of changes; and
B. reacting to the response.

46. A method of reporting security information according to claim 45, wherein reacting to the response includes forwarding the response to one or more information providers.

47. A method of reporting security information according to claim 45, wherein reacting to the response includes fixing a problem indicated in the response.

48. A method of managing information regarding a person's security from a plurality of information sources, comprising:
a. obtaining initial information about the person;
b. obtaining a baseline set of personal information from a plurality of information providers and at least two of the information providers attend to personal information in a separate class of information;
c. receiving a new set of personal information;
d. comparing the new set of personal information to the baseline set of personal information; and
e. reporting any changes between the new set of personal information and the baseline set of information to the person.
f. establishing the new set of personal information as the baseline set of information
g. repeating steps c through f.

49. A method of reporting security information according to claim 48, wherein receiving the new set of personal information occurs periodically.

50. A method of reporting security information according to claim 49, wherein the period is regular.

51. A method of reporting security information according to claim 49, wherein the period one of a once a day, once a week, once a month, once a quarter, or once a year.

52. A method of reporting security information according to claim 49, wherein the period varies.

53. A method of reporting security information according to claim 48, further comprising formatting the report before reporting the changes to the person.

54. A method of reporting security information according to claim 53, wherein formatting the report includes creating a presentation about the changes that the person will easily understand.

55. A method of reporting security information according to claim 54, wherein the presentation is a visual presentation.

56. A method of reporting security information according to claim 48, further comprising consolidating two or more reports of changes.

57. A method of reporting security information according to claim 56, wherein consolidating includes placing two or more changes into one presentation.

58. A method of reporting security information according to claim 56, wherein consolidating includes combining two or more changes into one new report.

59. A method of reporting security information according to claim 48, further comprising:
a. receiving a response from the person to one or more reports of changes; and
b. reacting to the response.

60. A method of reporting security information according to claim 59, wherein reacting to the response includes forwarding the response to one or more information providers.

61. A method of reporting security information according to claim 59, wherein reacting to the response includes fixing a problem indicated in the response.

62. An information receiving system to report security information to a person, comprising
a. a plurality of information providers, wherein at least one information provider database attends to a separate class of information;
b. an electronic device operated by the person; and
c. an information receiver communicatively coupled by the internet to each of the plurality of information provider databases and communicatively coupled to the electronic device, wherein the information receiver receives personal information from the plurality of information provider databases and sends notices about the personal information to the electronic device.

63. A system to report security information according to claim 62, wherein the electronic device is one of a computer, a display device, a wireless receiver, a cellular phone, a personal digital assistant, or a telephone.

64. A system to report security information according to claim 62, wherein the electronic device and the information receiver are integrated into one device.

65. An information receiver for reporting security information from two or more classes of information to a person, comprising:
a. a presentation engine;
b. one or more databases, communicatively coupled to the presentation engine, to store personal information from two or more classes of information; and
c. one or more communication engines, communicatively coupled to one or more of the databases, to communicate with two or more information providers.

66. An information receiver according to claim 65, further comprising an information portal, communicatively coupled to the presentation engine and to an electronic device operated by a person, to interface with the person regarding the person's personal information.

67. An information receiver according to claim 66, further comprising a registration system, communicatively coupled to the presentation engine and to the information portal, to establish access, to the personal information, for a person.

68. An information receiver according to claim 66, further comprising an authentication system, communicatively coupled to the presentation engine and to the information portal, to protect the person's personal information from unauthorized access.

69. An information receiver according to claim 66, further comprising a permissions system, communicatively coupled to the presentation engine and to the information portal, to restrict access to the person's personal information.

70. An information receiver according to claim 66, further comprising an information vault, communicatively coupled to the presentation engine and to the information portal, to securely store the person's personal information.

71. A method of providing personal information, comprising:
a. connecting to an information receiver that is connected to a plurality of information providers, and at least one of the information providers attends to personal information in a separate class of information;
b. obtaining initial information about a person using the information receiver;
c. sending the personal information to the information receiver for forwarding to the person; and
d. awaiting a response to the sent personal information.

72. A method of receiving personal information from an information receiver that is connected to two or more information providers, comprising:
a. providing initial information to the information provider;
b. awaiting the information receiver to establish connections with a plurality of information providers, and at least one information provider attends to personal information in a separate class of information; and
c. receiving a notification about personal information from one or more information providers.

73. A method of receiving personal information according to claim 72, wherein the notification includes personal information from two or more classes of information.
